(19) United States
(12) Patent Application Publication
(10) Pub. No.: US 2024/0263659 A1
(43) Pub. Date: Aug. 8, 2024

(54) Releasable Expansion Bolt And Connection Assembly And Method To Provide Such Connection Assembly

(71) Applicant: Heico Befestigungstechnik GmbH, Ense-Niederense (DE)

(72) Inventors: Norbert Schneider, Ense-Niederense (DE); Jens Kothenschulte, Ense-Niederense (DE)

(21) Appl. No.: 18/433,669

(22) Filed: Feb. 6, 2024

(30) Foreign Application Priority Data
Feb. 7, 2023 (DE) 10 2023 102 863.4

(51) Int. Cl. F16B 13/06; F16B 5/02

(52) U.S. Cl. CPC F16B 13/065; F16B 5/0258

(57) ABSTRACT

A releasable expansion bolt having an expansion sleeve with a first end, a second end, a cylindrical outer lateral surface and, on the inside, an inner cone section having a cross-sectional area that tapers towards the second end; a cone bolt with a cone section which interacts with the inner cone section for expanding the expansion sleeve as a result of an axial relative movement of the expansion sleeve and the cone bolt; and a tensioning device connected to the first end section of the expansion sleeve for adjusting the cone bolt in the axial direction relative to the expansion sleeve. The tensioning device comprises a pressure bolt held in a form-fitting manner in the axial direction in the area of the first end section of the expansion sleeve and adjustable in the axial direction relative to the expansion sleeve. An outer end of the pressure bolt has a foot opposite the driving contour that acts on the cone bolt when tightening the pressure bolt to expand the expansion sleeve. The end surface of the cone bolt facing the tensioning device has at least one connection contour for connecting, in a form-fitting manner in the axial direction, a connection part of a release tool for releasing the expansion bolt. Also described is a connection arrangement and a method for forming such a connection arrangement.

### RELATED APPLICATION

This application claims foreign priority to German application DE 10 2023 102 863.4 filed Feb. 7, 2024, which is incorporated-by-reference herein.

### BACKGROUND

The disclosure relates to a releasable, or detachable, expansion bolt having: an expansion sleeve with a first end, a second end, a cylindrical outer shell surface and, on the inside, an inner cone section which tapers the cross-sectional area towards the second end; a cone bolt with a cone section which interacts with the inner cone section of the expansion sleeve for expanding the same as a result of an axial relative movement of the expansion sleeve and the cone bolt; and a tensioning device connected to the end section providing the first end of the expansion sleeve for adjusting the cone bolt in the axial direction relative to the expansion sleeve.

Expansion bolts are used to create form-fitting connections, such as flange connections, when particularly high torques or transverse forces with respect to the flange axis have to be transmitted. One area of application for such expansion bolts is wind turbines, for example to create a torsionally rigid connection between two shaft flanges in the drive train.

Expansion bolts are often used for such form-fitting connections, with their bolt engaging in a blind bore. An expansion bolt of the type in question comprises a bolt which can have a threaded section as an anchoring means, with which it is fixed in an internally threaded bore made in a blind bore of a first mounting part. An anchoring acting in the axial direction of the bolt is required to apply the desired tensile forces when tensioning it. This bolt has a frustoconical cone section that acts on an expansion sleeve seated thereon with a complementary inner cone contour. Such a bolt is therefore also referred to as a cone bolt in the context of these statements. The cone section is tapered away from the anchoring means of the cone bolt. The taper is therefore carried out in the direction of the mouth of the blind bore. By moving the expansion sleeve relative to the cone bolt in the axial direction, the former can be expanded. The expansion sleeve is typically slotted. Such an expansion bolt is known from EP 2 191 150 B1. In this expansion bolt, the expansion sleeve has an external thread in its section protruding from a mounting bore. At the end opposite the anchoring means designed as a threaded section, the cone bolt carries a threaded section onto which a clamping nut, typically with an outer tool contour, is screwed for attaching a tensioning tool. A clamping nut is screwed onto the external thread section of the expansion sleeve. After fixing the cone bolt with its anchoring means designed as a threaded section in the blind bore of a first assembly part, the expansion sleeve is inserted into the assembly bore. Care must be taken to ensure that a gap remains between the clamping nut and the outside of the second assembly part. The clamping nut is then screwed onto the threaded section of the cone bolt until it comes in contact with the expansion sleeve. By screwing it on further, the expansion sleeve is pressed into the mounting bore against the background of the anchoring of the cone bolt in the blind bore against the taper of the cone section directed towards the clamping screw and the inner cone contour of the expansion sleeve. This requires the expansion sleeve to expand until the gap described above is closed. The radial pretensioning, which is introduced via the expansion sleeve into the wall of the two mounting parts to be clamped surrounding the mounting bore, can be set via the gap width between the clamping nut and the outside of the second assembly part before the clamping nut is tightened. Further tightening of the clamping nut after closing the gap generates the desired axial force on the assembly parts to be clamped together.

Another expansion bolt is known from EP 3 658 785 B1. In this expansion bolt, the cone sections taper in the direction of the thread provided on the foot side with respect to the cone bolt, with which the expansion bolt is connected to the clamping abutment. With this expansion bolt, the expansion sleeve has a clamping flange that projects in the radial direction. The tensioning device is located between the clamping flange and the surface of the mounting part arranged on the operating side, and is tensioned via a plurality of circumferentially distributed clamping bolts while simultaneously being supported on the surface of the operating-side mounting part. In this respect, with this expansion bolt, the sleeve is pulled out of the expansion bolt bore of the assembly parts that accommodates the expansion bolt. An advantage of this expansion bolt is that it can be released using simple means by applying a releasing force acting in the axial direction.

In addition to expansion bolts of the type described above, expansion bolts are also used where the expansion bolt is not connected to an axial clamping abutment, be it a threaded bore in the assembly part located away from the operating side or an abutment nut, if the threaded section of the expansion bolt passes through the assembly parts to be connected to one another and a threaded bearing nut is screwed onto the threaded section. These expansion bolts are used when mainly transverse forces with respect to the axis of the expansion bolt have to be absorbed between the assembly parts to be connected to one another. With this expansion bolt, the conical taper of the expansion sleeve and that of the cone bolt interacting with it are oriented towards the operating side. This expansion bolt is tensioned by applying a tensile force acting on the cone bolt.

A common feature of the above-described expansion bolts is that in order to tighten them, the tensioning tool must be supported on the surface of a mounting part facing the operating side. This implies that there must be appropriate space on the outside of the assembly parts to be connected in the radial direction to the expansion bolt bore, specifically for accommodating the tensioning device and for attaching a tensioning tool. However, this is not always the case.

Such expansion bolts are typically tensioned using hydraulic tensioning tools that are operated at very high pressures (typically several hundred bar). An oil jet emerging from a possible leak can seriously injure people. From a safety perspective, this is particularly problematic when such expansion bolts are arranged in a confined space, for example within a hollow shaft, and have to be tensioned there. This is necessary, for example, when connecting the rotor shaft of a wind turbine to the transmission shaft. For this purpose, a mechanic must go into the hollow shaft with the tensioning tool. If there is a leak in the hydraulics, the mechanic cannot escape the danger area quickly enough to be protected from injury.

U.S. Pat. No. 4,135,432 and US 2004/0136802 A1 teach clamping bolts whose expansion sleeve is anchored in a form-fitting manner in the axial direction in a borehole. These expansion bolts are not releasable.

The foregoing examples of related art and limitations therewith are intended to be illustrative and not exclusive. Other limitations will become apparent to those skilled in the art upon a reading of the specification and a study of the drawings.

### SUMMARY

The following embodiments and aspects thereof are described and depicted in conjunction with systems, tools, and methods which are meant to be illustrative and not limiting in scope. In various embodiments, one or more problems have been reduced or eliminated, while other embodiments are directed to other improvements.

Proceeding from this background, the disclosure proposes an expansion bolt that can not only be used in confined installation conditions but can also be tensioned, or clamped, using simpler means.

One aspect of the disclosure relates to an expansion bolt. For example, the expansion bolt may comprise: an expansion sleeve with a first end, a second end, a cylindrical outer lateral surface, and, on an inside thereof, an inner cone section having a cross-sectional area that tapers towards the second end, a cone bolt with a cone section which interacts with the inner cone section for expanding the expansion sleeve as a result of a relative movement of the expansion sleeve and the cone bolt in an axial direction, and a tensioning device connected to a first end section of the expansion sleeve for adjusting the cone bolt in the axial direction relative to the expansion sleeve, the first end section providing the first end of the expansion sleeve; wherein the tensioning device comprises a pressure bolt, which is held in a form-fitting manner in the axial direction in an area of the first end section of the expansion sleeve and which is adjustable in the axial direction relative to the expansion sleeve via a driving contour at an outer end of the pressure bolt, the pressure bolt having a foot opposite the driving contour that acts on the cone bolt when tightening the pressure bolt to expand the expansion sleeve; and wherein the cone bolt comprises at least one connection contour for connecting, in a form-fitting manner in the axial direction, a connection part of a release tool for releasing the expansion bolt by pulling the cone bolt out of the expansion sleeve, with the at least one connection contour introduced into an end surface of the cone bolt facing the tensioning device.

Another aspect relates to a connection assembly including such an expansion bolt. For example, the connection assembly may comprise the expansion bolt and at least two assembly parts to be connected to one another, wherein: the assembly parts each have expansion bolt bores which are coaxial with one another and into which the expansion bolt is inserted and clamped therein as a result of the radial expansion of the expansion sleeve when the expansion bolt is tensioned; and when the expansion bolt is tensioned, an outer side of the tensioning device is flush with or lowered relative to an adjacent surface of the assembly part arranged on an operating side of the connection assembly.

Another aspect relates to a method for forming such a connection assembly. For example, the method may comprise the steps of: arranging the assembly parts so that the expansion bolt bores of the assembly parts are coaxially aligned with each other; inserting the expansion bolt, which is pre-assembled with regard to components thereof, into the expansion bolt bores of the assembly parts; and tensioning the expansion bolt by tightening the pressure bolt using a motor-driven tensioning tool, initially torque-controlled up to a pre-tightening torque in order to eliminate radial play between the expansion bolt and the expansion bolt bores, and then path-controlled via an angle measurement in order to press the cone bolt into the expansion sleeve and expand the expansion sleeve in a defined manner.

The expansion bolt does not require an abutment acting in the axial direction in order to be tensioned. When this expansion bolt is tensioned, it represents a closed force system. This is of particular advantage since the expansion bolt can therefore be clamped in a threadless bore, in particular a threadless blind bore. This is achieved by moving the cone bolt in the expansion bolt to expand the expansion sleeve in order to tension the expansion bolt. This movement of the cone bolt occurs in the axial direction away from the operating side and the pressure bolt is supported on the cone sleeve in a form-fitting manner in the axial direction. The expansion bolt therefore does not require an additional clamping abutment, as is typically the case with conventional expansion bolts. Since in this expansion bolt, the cone bolt is pressed into the expansion sleeve in accordance with the intended orientation of the cone tapers, no surface portion of the mounting part on the operating side is required to place a clamping abutment. This explains the extremely small amount of space required by such an expansion bolt. The expansion bolt itself does not require any more installation space than is already provided by the expansion bolt bore. This means that this expansion bolt can be designed so that it does not protrude in the radial direction beyond the outer diameter of the expansion bolt bore. Since the pressure bolt is arranged centrally in relation to the longitudinal axis of the expansion bolt, the space required for placing a tensioning tool is also reduced to a necessary minimum. This minimum is only determined by the size of the tensioning tool used. As a result of the central arrangement of the single pressure bolt provided for expanding this expansion bolt, it can be tightened with a relatively small tensioning tool and the expansion bolt can thus be tensioned. Such an expansion bolt can easily be tensioned even with larger diameters using a powered tensioning tool, such as a pneumatic screwdriver or electrically with a powerful cordless screwdriver.

It is advantageous if such a tensioning tool has a coaxial reaction arm for its force transmission head, which is engaged with its driving contour for tightening the pressure bolt of the expansion bolt, with the reaction arm supported in a form-fitting manner in the direction of rotation on the structures provided on the operating end of the expansion bolt. This support can be used at the same time so that the expansion sleeve remains stationary and the tensioning of the pressure bolt alone leads to an axial adjustment movement of the cone bolt within the expansion sleeve. However, such a reaction arm support is fundamentally not necessary. The expansion bolt can also be tensioned without such a reaction arm support or with another reaction arm support. In such a case, the frictional connection between the outer cylindrical shell surface of the expansion sleeve and the inner wall of the expansion bolt bore is used.

It is entirely possible to design an expansion sleeve of such an expansion bolt that carries clamping structures on the outside, for example circumferentially arranged clamping ribs, which are pressed into the wall of the expansion bolt bore as a result of the expansion sleeve expanding. Then the expansion bolt can also be used to transfer axial forces between the assembly parts in a form-fitting manner.

According to some embodiments of such an expansion bolt, the pressure bolt is engaged with the expansion sleeve in its first end section—the operating end section—via a thread. As a result, the pressure bolt is supported on the expansion sleeve in a form-fitting manner in the axial direction and at the same time it is adjustable in the axial direction relative to the expansion sleeve by screwing it in. Such an embodiment is particularly suitable for expansion bolts with smaller diameters.

According to some embodiments, the pressure bolt is held on the expansion sleeve with the interposition of an abutment body and is adjustable relative thereto in the axial direction. This abutment body is connected to the inside of the first end section of the expansion sleeve in a form-fitting manner in the axial direction. Furthermore, such an abutment body has a central through bore equipped with an internal thread. The pressure bolt, which meshes with this internal thread, passes through the central through bore of the abutment body. Even in such a configuration, the flow of force is closed when the expansion bolt is tensioned. According to a preferred example, the abutment body is screwed to the expansion sleeve. However, a different type of form-fitting connection in the axial direction can also be provided at this point, for example a plug-and-turn connection in the manner of a bayonet lock. If a threaded connection is provided between the expansion sleeve and the abutment body, the expansion sleeve has an internal thread in its first end section and the abutment body has a complementary external thread. Again, no more space is required in the radial direction than the diameter of the expansion sleeve.

When designing an expansion bolt with such an abutment body, which is connected and held to the expansion sleeve via a thread, it is expedient if this screw connection is equipped with an abutment by which the screw-in depth of the abutment body is limited. According to one embodiment, a circumferential abutment flange protruding on the outside is provided on the abutment body, which flange acts against the end face of the first end of the expansion sleeve. According to another embodiment, there is an abutment within the expansion sleeve against which the abutment body acts. In such an embodiment, the abutment shoulder located within the expansion sleeve can be designed at such a depth that the abutment body with the pressure bolt passing therethrough is completely immersed in the first end section of the expansion sleeve when the expansion bolt is tensioned, and therefore does not protrude relative to the first end of the expansion sleeve. An advantage of such a design is that, if the two mounting parts are flanges for connecting two shaft parts, for example, no fasteners protrude from the top of the flanges. Then the first end section of the expansion sleeve can also have support structures for the torque-locking connection of a reaction arm of a tensioning tool.

In another embodiment, the reaction arm of the tensioning tool can be supported on the abutment body. Then the support structures for the torque-locking connection of the reaction arm are provided on the abutment body instead of on the cone sleeve. In the latter design, the thread direction between the internal thread of the abutment body and its external thread is preferably opposite to one another, so that there is no risk that the screw connection of the abutment body to the expansion sleeve is loosened when the pressure bolt is tightened.

The design of an expansion bolt whose pressure bolt is connected to the expansion sleeve with the interposition of an abutment body is particularly suitable for expansion bolts with a larger diameter. In such a case, it is expedient if a pressure distribution element is arranged between the foot of the pressure bolt, i.e. the end of the pressure bolt which is opposite its driving contour, and the cone bolt. Such a pressure distribution element typically distributes the clamping force of the pressure bolt, which is directed only at the center area due to the smaller diameter of the pressure bolt compared to the diameter of the cone bolt, over the available surface of the end of the cone bolt facing the pressure bolt. It has proven to be expedient if the clamping force for axially adjusting the cone bolt for tensioning the expansion bolt is applied to the cone bolt circumferentially in its outer edge area rather than just in a limited central area. If such a force transmission from the pressure bolt to the cone bolt is provided, the force distribution element can be designed in the manner of a disk and can carry a circumferential pressure ring on its side facing the cone bolt in the area of its radial end.

The expansion bolt can also be released using simple means. This is because the cone bolt is pressed into the expansion sleeve in the axial direction to tension the expansion bolt. Therefore, the expansion bolt can be easily released by pulling the cone bolt out of the expansion sleeve. Typically, the expansion sleeve itself or the outside of an abutment body forms the counter bearing. In order to pull the cone bolt out of its position within the expansion sleeve that clamps the expansion bolt, it is provided to introduce a negative contour as a connection contour centrally into the end surface of the cone bolt facing the pressure bolt, to which a connection part of a release tool can be connected in a form-fitting manner in the axial direction. Such a connection contour can be, for example, an internal thread or a component of a bayonet lock. This connection contour is made accessible to release the expansion bolt. Depending on the design of the expansion bolt, it may only be necessary to unscrew the pressure bolt or to unscrew the abutment body together with the pressure bolt from the threaded sleeve and, if present, to remove the force distribution element. The connection contour is then accessible from the axial direction from the operating side.

In an embodiment in which the operating side of the expansion bolt has at least one support structure for supporting a torque of a reaction arm of a tensioning tool, it is expedient if several support structures are present and these are arranged concentrically to the pressure bolt and at the same angular distance from one another. The reaction arm to be engaged is designed coaxially and has a corresponding complementary engagement contour.

In a connection assembly in which at least two assembly parts are to be connected to one another by such an expansion bolt, it is expedient if an abutment shoulder is provided within the expansion bolt bore of an assembly part to define the insertion depth of the expansion bolt. This abutment shoulder acts against the free end face or a shoulder on the outer diameter of the expansion sleeve.

A connection arrangement, comprising at least two assembly parts to be connected to one another and at least one expansion bolt, may be created as follows:

First, the assembly parts are arranged relative to one another in such a way that their expansion bolt bores are coaxially aligned with one another.

The expansion bolt to be inserted therein is pre-assembled, meaning that the cone bolt is inserted into the expansion sleeve and fixed in place by the tensioning device, and may even even slightly pretensioned. This means that the pressure bolt is also screwed into the expansion sleeve, possibly with the interposition of an abutment body. This pre-assembled expansion bolt is inserted into the mutually coaxial expansion bolt bores from one side—the operating side of the connection assembly—preferably up to an abutment or stop shoulder located in the expansion bolt bore. The expansion bolt acts against the abutment shoulder of the expansion sleeve pointing in this direction, preferably against the free end face of the expansion sleeve. The abutment shoulder is typically located at such a depth in the expansion bolt bore so that, depending on the design of the expansion bolt, the cones cover the two assembly parts in the desired ratio. Due to the design of the expansion bolt, it can be inserted with its expansion sleeve into an expansion bolt bore so that it is flush with the adjacent surface of the assembly part facing the operating side. This is easily possible with the described design of the expansion bolt, since the expansion sleeve remains stationary within the expansion bolt bores when the expansion bolt is tensioned.

The expansion bolt is then tensioned. For this purpose, a motor-driven tensioning tool is typically placed on the pressure bolt, typically an electric tensioning tool, in particular a battery-operated tensioning tool such as a cordless screwdriver with a corresponding receptacle for the driving contour of the pressure bolt. Such a tensioning tool preferably has a reaction arm, via which the reaction torque that arises in response to the tightening torque is supported on the expansion sleeve. Alternatively, the reaction moment can also be supported on one or more components which are connected in a form-fitting manner to the expansion sleeve. The screwing-in process is preferably carried out in a path-controlled manner such that a certain screwing activity must be carried out in order to move the cone bolt in the expansion sleeve by a defined adjustment path until the expansion bolt is tensioned as intended. When using a powered tensioning tool, such as a cordless screwdriver, the distance is recorded via the already existing motor control, in which the changes in the angle of rotation of the rotor or the output shaft are recorded. The path control process for clamping the expansion bolt with a predetermined radial pretension begins when a certain pre-tightening torque has previously been applied to the expansion bolt in order to eliminate the play required to insert the expansion bolt into the expansion bore. Finally, only the adjustment path in which a radial pretension or preload is also introduced into the wall of the expansion bolt bores should have an influence on the control. An advantage of such a path control is that friction within the expansion bolt, which influences torque control for clamping such an expansion bolt, does not adversely affect the radial pretension to be introduced.

The connection arrangement can also be easily released or detached again. To do this, the first step is to unscrew the pressure bolt. The cone bolt is then pulled out by a tensile force applied to it. This tensile force can be applied, for example, via a threaded rod screwed into the expansion sleeve. Preferably, support for applying the tensile force acting on the threaded rod is provided on the expansion sleeve, for example with a nut or a corresponding tool.

In addition to aspects and embodiments described above, further aspects and embodiments will become apparent by reference to the drawings, wherein like reference numerals generally designate corresponding structures in the several views.

### BRIEF DESCRIPTION OF THE DRAWINGS

The description below is provided with reference to the attached figures, wherein:

FIG. 1 is an exploded perspective view of an expansion bolt according to the disclosure,

FIG. 2 is a sectional view of a connection arrangement using the expansion bolt of FIG. 1 with the expansion bolt not tensioned,

FIG. 3 shows the connection arrangement of FIG. 2 with the expansion bolt tensioned,

FIG. 4 shows the connection arrangement of FIG. 3 with a representation of the flow of force when tensioning the expansion bolt,

FIG. 5 shows a sectional view of the connection arrangement of FIGS. 2-4 with a release tool for releasing the expansion bolt before actuation of the release tool,

FIG. 6 shows the connection arrangement of FIG. 5 with the released expansion bolt, and

FIG. 7 shows a sectional view of a connection arrangement with alternative axial positions of the expansion bolt relative to the parting line between the assembly parts compared to FIG. 2.

It is to be understood that the invention is not limited in application to the details of particular arrangements shown in the drawings, since the invention is capable of other embodiments. Embodiments and figures disclosed herein are to be considered illustrative rather than limiting.

### DETAILED DESCRIPTION

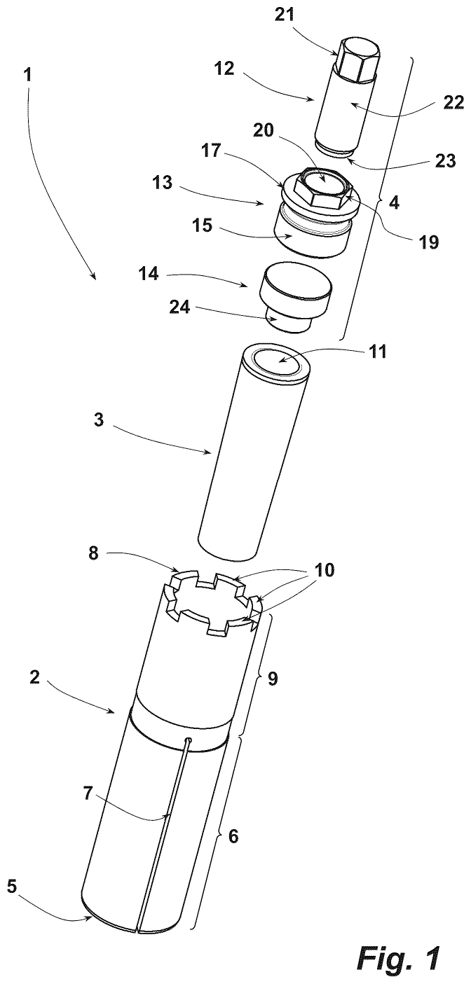

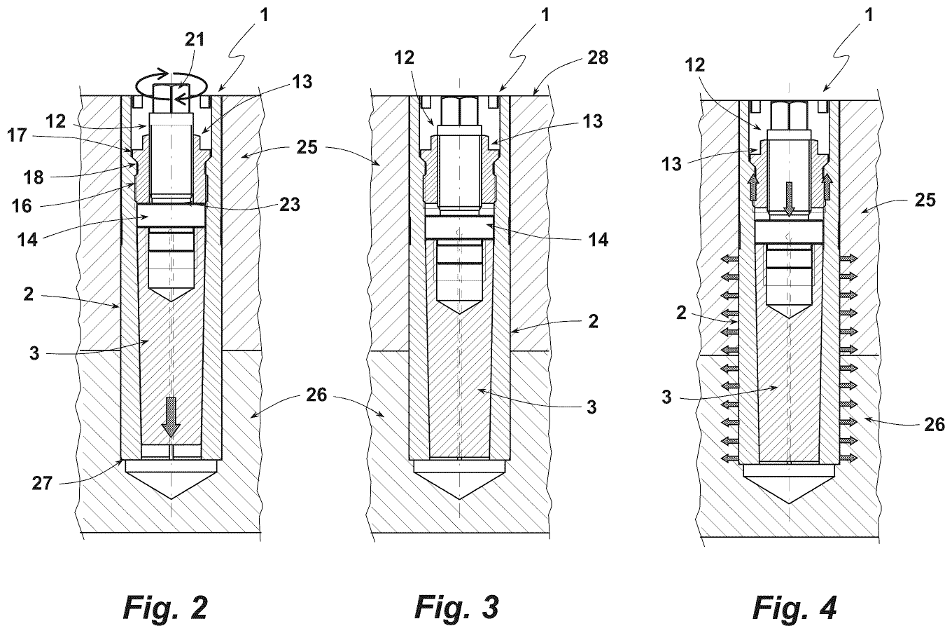

With reference to FIG. 1, an expansion bolt 1 comprises an expansion sleeve 2, a cone bolt 3 and a tensioning device 4. The expansion sleeve 1 of the example embodiment shown has a cylindrical outer shell surface and is divided into two sections with regard to its expandability. A section 6 encompassing the second end 5 of the expansion sleeve is equipped on the inside with a conical surface which tapers towards the second end 5 (as can be seen in FIGS. 2-6). This section 6 is slotted. Such a slot 7 can be seen in FIG. 1. In the example embodiment shown, the section 6 has two diametrically opposed slots 7. The slots 7 serve the purpose of allowing the section 6 to be widened and therefore expanded. This section 6 can therefore also be referred to as an expansion section. Section 6 is followed by a section 9 carrying the first end 8 of the expansion sleeve 2, which is also referred to as the first end section in the context of these statements. The inner wall structuring of the first end section 9 is described below in relation to FIG. 2.

In the first end 8 of the expansion sleeve 2, several support structures 10, arranged at the same angular distance from one another, are provided which enable a form-fitting connection to a matching counter contour of a reaction arm of a tensioning tool. In a preferred embodiment, these support structures are designed in the manner of the crown end of a crown nut.

The cone bolt 3 of the example embodiment shown is tapered conically over its entire longitudinal extent with its outer shell surface. The cone section thus extends over the entire axial extent of the cone bolt 3. The taper angle of the cone bolt 3 and that of the inner wall of the expanding section 6 of the expansion sleeve 2 are the same. The cone bolt 3 has at least one thread 11 in order to attach a release device to it. The thread 11 is shown as an internal thread.

A tensioning device 4 is used to tension the expansion bolt 1. In the example embodiment shown, the tensioning device comprises three components, namely a pressure bolt 12, an abutment body 13 and a force distribution element 14. The abutment body 13 is designed to be inserted into the first end section 6 of the expansion sleeve 2 and to be clamped in the axial direction with the expansion sleeve 2. For this purpose, the abutment body 13 has an external thread section 15, which cooperates with a complementary internal thread 16 of the expansion sleeve 2 in its first end section 6 (see FIG. 2). If the abutment body 13 is engaged with its external thread section 15 with the internal thread 16 of the expansion sleeve 2, it is connected in a form-fitting manner in the axial direction to the expansion sleeve 2 and held by it. The abutment body 13 further has an abutment flange 17 arranged above the external thread section 15, which projects beyond the external thread section 15 in the radial direction. The abutment flange 17 serves to limit a screwing movement of the abutment body 13 into the first end section 6 of the expansion sleeve 2. For this purpose, the expansion sleeve 2 carries an abutment shoulder 18 in its first end section 6, against which the abutment flange 17 of the abutment body 13 acts (see FIG. 2). For screwing the abutment body 13 into the expansion sleeve 2 and in particular for clamping the abutment body 13 with the expansion sleeve 2, the abutment body 13 has a rotary driving contour 19 on the top side, which contour 19 is designed as a hexagon in the example embodiment shown. The abutment body 13 has a central through bore 20. The central through bore is equipped with an internal thread.

The pressure bolt 12, with which the expansion bolt 1 is tensioned, has atone end a driving contour 21, which is also designed as a hexagon in the example embodiment shown. A threaded section 22 borders the driving contour 21 and has an external thread that is complementary to the internal thread of the abutment body 13. The pressure bolt 12 thus meshes with its threaded section 22 with the internal thread of the through bore 20.

With its foot 23 opposite the driving contour 21, the pressure bolt 12 is supported on the force distribution element 14. The force distribution element 14 is designed in the manner of a disk, with a diameter that can be inserted into the first end section 6 of the expansion sleeve 2 with the necessary radial play. The force distribution element 14 of the illustrated embodiment has a pin 24 formed on the side facing away from the pressure bolt 12, which engages in the driving contour 11 of the cone bolt 3.

FIG. 2 shows the composite and therefore pre-assembled expansion bolt 1 inserted into the mutually coaxially arranged expansion bolt bores of two assembly parts 25, 26 to be connected to one another. The expansion bolt 1 is pre-assembled by inserting the cone bolt 3 into the expansion sleeve 2 so that the two interacting cone surfaces rest against each other. The force distribution element 14 is then inserted into the expansion sleeve 2. Subsequently, the abutment body 3 with or without a pressure bolt 12 threaded therein is inserted into the expansion sleeve 2 with its external thread section 15 screwed onto the internal thread 16 of the expansion sleeve 2, until the abutment flange 17 of the abutment body 13 rests on the abutment shoulder 18 of the expansion sleeve, so that the abutment body 13 with its abutment flange 17 can be clamped with the abutment shoulder 18 of the expansion sleeve 2. In the example embodiment shown, the abutment surfaces that interact with one another are inclined at an angle of 45° in the direction of the longitudinal axis of the expansion bolt 1. The inclination of the interacting abutment surfaces of 45° in the direction of the longitudinal axis provided in the example embodiment shown may also be designed differently. For example, an alignment of the interacting abutment surfaces of 90° relative to the longitudinal axis or other angles are also possible. If the pressure bolt 12 has not been mounted together with the abutment body 13, the pressure bolt 12 is finally screwed with its threaded section 22 into the through bore 20 of the abutment body 13, which is equipped with an internal thread. In this respect, the expansion bolt 1 including the tensioning device 4 can be handled as one piece. None of the components of the expansion bolt 1 protrude beyond the outer diameter of the cylindrical shell surface of the expansion sleeve 2.

The expansion bolt bore of the mounting part 26 has an abutment shoulder 27, by means of which the diameter of the expansion bolt bore is reduced. This abutment shoulder 27 acts against the free end face of the expansion sleeve 2, which provides the second end 5, in order to position the expansion bolt 1 relative to the parting line between the mounting parts 25 and 26.

In an alternative embodiment, both the bore in the first assembly part and the expansion sleeve in the area of the first end section are designed with a larger diameter than the bore in the second assembly part. This results in an abutment shoulder in the axial direction between the expansion sleeve 2 and the first assembly part, with which the expansion bolt is positioned relative to the parting line.

In another alternative embodiment, both the bore in the first assembly part and the expansion sleeve up to the parting line are designed with a larger diameter than the bore in the second assembly part. This results in an abutment shoulder in the axial direction between the expansion sleeve and the second assembly part, with which the expansion bolt is positioned relative to the parting line.

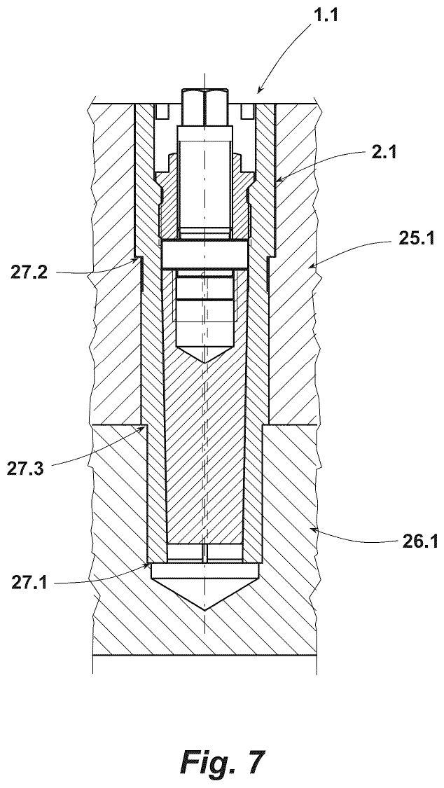

In FIG. 7, the two alternatives mentioned above for supporting an expansion sleeve 2.1 in the expansion bolt bore are shown cumulatively. The expansion sleeve 2.1 has an abutment shoulder at the free end of the first section. This abutment is identified in FIG. 7 with reference numeral 27.1. A second abutment shoulder 27.2 is located within the expansion bolt bore made in the mounting part 25.1. A third abutment shoulder 27.3 is located in the area of the parting line between the two assembly parts 25.1, 26.1. This view serves to illustrate the different options for forming an abutment shoulder to limit the insertion movement of the expansion sleeve 2.1 into the expansion bolt bores. Typically only one abutment shoulder will be provided.

A suitable tensioning tool is used to tension the expansion bolt 1. The tensioning tool is placed on the driving contour 21 of the pressure bolt 12. A cordless screwdriver is preferably used as a tensioning tool. In addition to its tool, which can be placed on the driving contour 21 of the pressure bolt 12, this tensioning tool has an annular reaction arm that surrounds the actual tensioning tool as a sleeve, the free end face of which is designed to be complementary to the structures 10 of the first end 8 of the expansion sleeve 2. In this respect, a form-fitting engagement is established between the reaction arm of the tensioning tool and the expansion sleeve 2. The reaction arm does not rotate when the tool connected to the driving contour 21 performs a tensioning movement. Tensioning the pressure bolt 12 causes the pressure bolt 12 to act with its foot 23 against the top of the force distribution element 14. The force distribution element 14 distributes the axial force applied centrally in the middle area to the annular end face of the cone bolt 3 facing the pressure bolt 12, which is then inserted into the expansion sleeve 2 in the direction of the cone taper. This movement of the cone bolt 3 relative to the expansion sleeve 2 leads to an expansion of the expansion sleeve 2 in its expansion section 6. This axial movement of the cone bolt 3 when tensioning the expansion bolt 1 is indicated in FIG. 2 by a block arrow.

The expansion section 6 of the expansion sleeve 2 is designed with regard to its axial extent in relation to the expansion bolt bores of the two mounting parts 25, 26 such that the expansion section 6 engages with an approximately equal section in each expansion bolt bore.

FIG. 3 shows the expansion bolt 1 clamped with the two mounting parts 25, 26. This view illustrates that no components of the expansion bolt 1 protrude above the surface 28 of the mounting part 25 facing the operating side. The expansion sleeve 2 is matched to the intended depth of the mutually coaxial expansion bolt bores of the mounting parts 25, 26 or vice versa: the expansion bolt bores are adapted to the axial length of the expansion bolt 1. The screw-in depth or the adjustment path of the cone bolt 3 for tensioning the expansion bolt 1 is provided so that a defined radial pretension is exerted on the expansion bolt bores.

FIG. 4 shows the expansion bolt 1 connecting the mounting parts 25, 26 with the force introduced therein indicated schematically with block arrows. By expanding the expansion section 6 of the expansion sleeve 2, the radial pretension acts against the wall of the expansion bolt bores of the mounting parts 25, 26. The screwing-in movement of the pressure bolt 12 is also shown schematically in this illustration by a block arrow. This screwing-in movement is absorbed by the abutment body 13, which is held in the expansion sleeve 2 in a form-fitting manner in the axial direction, and on which the pressure bolt 12 is in turn held in a form-fitting manner in the axial direction. To tension the expansion bolt 1, no additional tensioning abutments, such as threads or the like, are required. The expansion bolt 1 is therefore an expansion bolt that has no external thread.

The monitoring or control of the clamping process is carried out using the procedural steps specified in the introduction to the description.

Since that the cone bolt 3 has been pressed into the expansion sleeve 2 in the axial direction for tensioning the expansion bolt 1, the expansion bolt 1 can also be released again using simple means and then removed from the expansion bolt bores. The release process is described below:

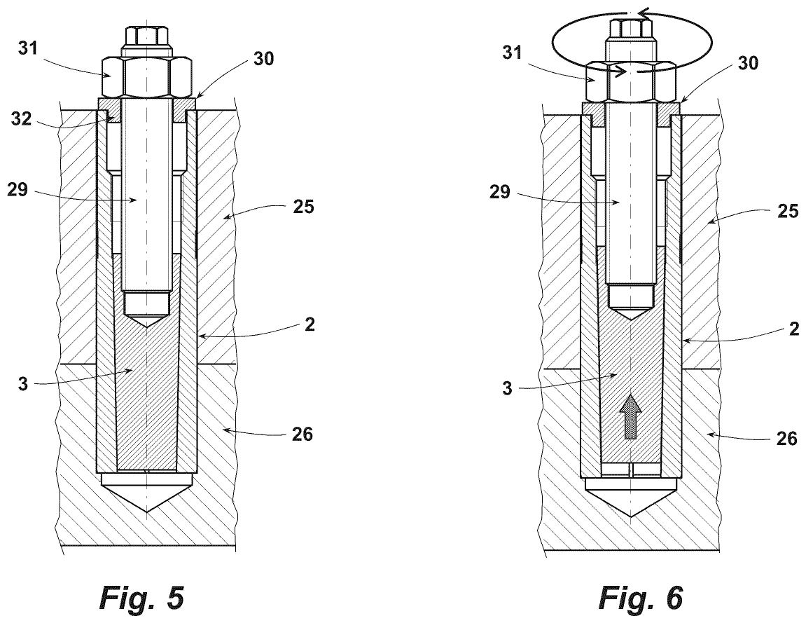

To release the connection arrangement, which comprises the two mounting parts 25, 26 connected to one another and the expansion bolt 1 connecting these mounting parts 25, 26, the pressure bolt 12 is screwed out of the abutment body 13. The abutment body 13 is then unscrewed from the expansion sleeve 2, though the latter step can also be performed together with the pressure bolt 12 located therein. In a next step, the force distribution element 14 is also removed from the expansion sleeve 2 such that the driving contour 11, which is designed as an internal thread in the example embodiment shown, is then accessible from the operating side. A threaded rod 29 is screwed into this driving contour 11 of the cone bolt 3 (see FIG. 5). At its end screwed into the driving contour 11, the threaded rod 29 carries a pin-like extension with a reduced diameter, with which the threaded rod 29 is clamped to the bottom of the bore providing the driving contour 11. The threaded rod 29 projects beyond the free end of the expansion sleeve 2 on the operating side. A support disk 30 is placed on the section of the threaded rod 29 protruding from the expansion bolt bore of the mounting part 25, and a nut 31 is then screwed onto the threaded rod 29. The nut 31 is supported on the top of the support disk 30. To guide the threaded rod 29 and to position the support disk 30, it has an annular extension 32 which engages in the expansion sleeve 2. By simply screwing the nut 31 onto the threaded rod 29 connected to the cone bolt 3, the cone bolt 3 is pulled out of the expansion sleeve 2, as indicated in FIG. 6 by a block arrow. If the cone bolt 3 has been pulled out of the expansion sleeve 2 sufficiently far so that the radial pretensioning is reduced, the cone bolt 3 and the expansion sleeve 2 can then be pulled out of the mutually coaxially arranged expansion bolt bores of the mounting parts 25, 26.

The invention has been described on the basis of exemplary embodiments. Without leaving the scope of the present claims, numerous further options for implementing them result for a person skilled in the art, without having to explain them in greater detail in the context of these statements.

While several aspects and embodiments have been discussed herein, those persons skilled in the art will recognize numerous possible modifications, permutations, additions, combinations and sub-combinations therefor, without these needing to be specifically explained or shown within the context of this disclosure. The claims should therefore be interpreted to include all such modifications, permutations, additions and sub-combinations, which are within their true spirit and scope. Each embodiment described herein has numerous equivalents.

The terms and expressions which have been employed are used as terms of description and not of limitation, and there is no intention in the use of such terms and expressions of excluding any equivalents of the features shown or described, or portions thereof, but it is recognized that various modifications are possible within the scope of the invention. Thus, it should be understood that although the invention has been specifically disclosed by preferred embodiments and optional features, modification and variation of the concepts herein may be resorted to by those skilled in the art, and that such modifications and variations are considered to be within the scope of this invention as defined by the claims. Whenever a range is given in the specification, all intermediate ranges and subranges, as well as all individual values included in the ranges given are hereby incorporated into this disclosure. When a Markush group or other grouping is used herein, all individual members of the group and all combinations and sub-combinations possible of the group are hereby individually included in this disclosure. In general, the terms and phrases used herein have their art-recognized meaning, which can be found by reference to standard texts, references and contexts known to those skilled in the art. Any above definitions are provided to clarify their specific use in the context of the invention.

LIST OF REFERENCE NUMERALS

| | |
|---|---|
| 1, 1.1 | expansion bolt |
| 2, 2.1 | expansion sleeve |
| 3 | cone bolt |
| 4 | tensioning device |
| 5 | second end |
| 6 | expanding section/section |
| 7 | slot |
| 8 | first end |
| 9 | section |
| 10 | support structure |
| 11 | connection contour/internal thread |
| 12 | pressure bolt |
| 13 | abutment body |
| 14 | force distribution element |
| 15 | external thread section |
| 16 | internal thread |
| 17 | abutment flange |
| 18 | abutment shoulder |
| 19 | rotary driving contour |
| 20 | through bore |
| 21 | driving contour |
| 22 | thread section |
| 23 | foot |
| 24 | pin |
| 25, 25.1 | assembly part |
| 26.1 | assembly part |
| 27, 27.1, 27.2, 27.3 | abutment shoulder |
| 28 | surface |
| 29 | threaded rod |
| 30 | support disk |
| 31 | nut |
| 32 | extension |

1. A releasable expansion bolt comprising:
an expansion sleeve with a first end, a second end, a cylindrical outer lateral surface, and, on an inside thereof, an inner cone section having a cross-sectional area that tapers towards the second end,
a cone bolt with a cone section which interacts with the inner cone section for expanding the expansion sleeve as a result of a relative movement of the expansion sleeve and the cone bolt in an axial direction, and
a tensioning device connected to a first end section of the expansion sleeve for adjusting the cone bolt in the axial direction relative to the expansion sleeve, the first end section providing the first end of the expansion sleeve,
wherein the tensioning device comprises a pressure bolt, which is held in a form-fitting manner in the axial direction in an area of the first end section of the expansion sleeve and which is adjustable in the axial direction relative to the expansion sleeve via a driving contour at an outer end of the pressure bolt, the pressure bolt having a foot opposite the driving contour that acts on the cone bolt when tightening the pressure bolt to expand the expansion sleeve,
wherein the cone bolt comprises at least one connection contour for connecting, in a form-fitting manner in the axial direction, a connection part of a release tool for releasing the expansion bolt by pulling the cone bolt out of the expansion sleeve, with the at least one connection contour introduced into an end surface of the cone bolt facing the tensioning device.

2. The expansion bolt of claim 1, wherein the pressure bolt is engaged with the expansion sleeve via a thread and adjustable relative to the expansion sleeve in the axial direction.

3. The expansion bolt of claim 1, wherein the tensioning device comprises an abutment body which is connected in a form-fitting manner in the axial direction to the first end section of the expansion sleeve on the inside of the expansion sleeve, wherein the abutment body has a central through bore equipped with an internal thread, and the pressure bolt meshes with the internal thread of the through bore of the abutment body.

4. The expansion bolt of claim 3, wherein the first end section of the expansion sleeve has an internal thread, the abutment body has a complementary external thread, and the abutment body is screwed to the expansion sleeve.

5. The expansion bolt of claim 3, wherein the abutment body consists of several components which are connected in a form-fitting manner to one another, with one of these components being screwed to the expansion sleeve, and another component having a through bore with an internal thread into which the pressure bolt is screwed.

6. The expansion bolt of claim 1, wherein, between the foot of the pressure bolt and the cone bolt, a force distribution element is arranged for transmitting a force provided via the foot of the pressure bolt to the cone bolt.

7. The expansion bolt of claim 6, wherein the force distribution element is designed as a disk having a diameter that is larger than a diameter of the foot of the pressure bolt.

8. The expansion bolt of claim 7, wherein the force transmission element carries an outer circumferential pressure ring on a side thereof facing the cone bolt.

9. The expansion bolt of claim 6, wherein, on a side of the force distribution element facing the cone bolt, the force distribution element carries a pin which engages in the connection contour.

10. The expansion bolt of claim 1, wherein the connection contour introduced into the cone bolt is an internal thread.

11. The expansion bolt of claim 1, wherein the tensioning device comprises an abutment body which is connected in a form-fitting manner in the axial direction to the first end section of the expansion sleeve, and wherein, at a radial distance from the pressure bolt, the expansion sleeve and/or the abutment body have/has at least one support structure accessible in the axial direction for form-fitting engagement and support of a reaction arm of a tensioning tool.

12. The expansion bolt of claim 11, wherein multiple support structures are arranged at a same angular distance from one another in a circumferential direction, and the support structures are designed in the manner of a crown end of a crown nut for engagement of a sleeve with an end face having a complementary engagement contour as a coaxial reaction arm of a tensioning tool.

13. A connection assembly comprising an expansion bolt according to claim 1, and at least two assembly parts to be connected to one another, wherein:
the assembly parts each have expansion bolt bores which are coaxial with one another and into which the expansion bolt is inserted and clamped therein as a result of the radial expansion of the expansion sleeve when the expansion bolt is tensioned, and
when the expansion bolt is tensioned, an outer side of the tensioning device is flush with or lowered relative to an adjacent surface of the assembly part arranged on an operating side of the connection assembly.

14. The connection assembly of claim 13, wherein an insertion depth of the expansion bolt into the expansion bolt bores of the assembly parts is limited by an abutment shoulder acting against the expansion sleeve.

15. A method for forming a connection assembly according to claim 13, comprising the steps:
arranging the assembly parts so that the expansion bolt bores of the assembly parts are coaxially aligned with each other,
inserting the expansion bolt, which is pre-assembled with regard to components thereof, into the expansion bolt bores of the assembly parts, and
tensioning the expansion bolt by tightening the pressure bolt using a motor-driven tensioning tool, initially torque-controlled up to a pre-tightening torque in order to eliminate radial play between the expansion bolt and the expansion bolt bores of the assembly parts, and then path-controlled via an angle measurement in order to press the cone bolt into the expansion sleeve and expand the expansion sleeve in a defined manner.
